(19) United States
(12) Patent Application Publication
(10) Pub. No.: US 2025/0309726 A1
(43) Pub. Date: Oct. 2, 2025

(54) ELECTRIC MOTOR ROTOR/STATOR AIR GAP CONTROL VIA HOUSING SUPPORTS WITH INTEGRATED COOLING CHANNELS

(71) Applicant: Canoo Technologies Inc., Torrance, CA (US)

(72) Inventors: Evan J. Filter, Newtown Square, PA (US); Abel Ardis, Austin, TX (US); Peter Kim, Gardena, CA (US); Karthik Siriyapuraju, Ferndale, MI (US); Jerry Hsieh, Las Vegas, NV (US); Majd Abdelqader, Redondo Beach, CA (US); Matthew Jackson Moore, Oklahoma City, OK (US); Leandro Peres de Oliveira, Redondo Beach, CA (US); Scott Kostohryz, Torrance, CA (US); Jhon Echeverri, Redondo Beach, CA (US)

(21) Appl. No.: 18/617,346

(22) Filed: Mar. 26, 2024

(51) Int. Cl. H02K 5/20; B60K 1/00; H02K 9/19; H02K 21/14

(52) U.S. Cl. CPC H02K 5/203; H02K 9/19; H02K 21/14; B60K 1/00; B60K 2001/006

(57) ABSTRACT

Improved rotor/stator air gap control within the electric traction motor for an electric vehicle is provided by stator supports projecting from interior sidewalls of the motor housing and contacting portions of peripheral surfaces of the stator core. The stator supports are spaced apart from a pilot bore receiving an end of the stator. Surfaces of the pilot bore contacting the stator core and surfaces of the stator support contacting the stator core are spaced apart, with oil channels in the intervening region allow flow of combined coolant and lubricant over the stator core. The portions of the stator core contacted by the surfaces of the pilot bore are preferably located between an end of the stator core and a midpoint between the end and an opposite end.

### TECHNICAL FIELD

This disclosure relates generally to cooling and lubrication of an electric traction motor for an electric vehicle. More specifically, this disclosure relates to support of a stator within a motor housing to facilitate motor cooling and lubrication.

### BACKGROUND

Current motor designs for electric vehicles may incorporate a rainfall manifold for motor cooling and lubrication of the type disclosed in U.S. Pat. No. 11,843,305. In one approach, the motor stator is supported by the motor housing on one end only, because the rainfall manifold cooling requires unrestricted liquid flow interaction with the motor stator. This single-ended support structure leads to a cantilevered stator condition, which can have excessive movement in the stator-to-rotor relative positioning, leading to potential reduction in motor air gap. Under certain drive modes or designs, rotor/stator contact was found to be possible, leading to the need for a design solution for such motor layout.

### SUMMARY

This disclosure relates to improved rotor/stator air gap control within the electric traction motor for an electric vehicle.

Improved rotor/stator air gap control within the electric traction motor for a vehicle using a rainfall motor cooling system is provided by stator supports projecting from interior sidewalls of the motor housing and contacting portions of peripheral surfaces of the stator core. The stator supports are spaced apart from a pilot bore receiving an end of the stator. Surfaces of the pilot bore contacting the stator core and surfaces of the stator support contacting the stator core are spaced apart, with oil channels in the intervening region allow flow of combined coolant and lubricant over the stator. The portions of the stator core contacted by the surfaces of the pilot bore are preferably located between an end of the stator core and a midpoint between the end and an opposite end.

In certain embodiments, a motor housing includes sidewalls and an end collectively forming a cavity configured to receive a stator having a stator core and windings on the stator core. A pilot bore is recessed into a portion of the end of the motor housing, the pilot bore sized to receive a portion of the stator, where sidewall surfaces of the pilot bore contact peripheral surfaces of the stator core for a first distance along an axial direction of the stator. Stator supports project from the sidewalls of the motor housing and contacting portions of the peripheral surfaces of the stator core, and the portions of the peripheral surfaces of the stator core contacted by the stator supports are spaced apart in the axial direction from the portions of the peripheral surfaces of the stator core contacted by the sidewall surfaces of the pilot bore. One or more channels each formed in the sidewalls of the motor housing between the pilot bore and the stator supports are each configured to leave a space between the sidewalls of the motor housing and the stator core to allow flow of combined coolant and lubricant over the surfaces of the stator adjoining the channels.

In certain embodiments, a method of cooling an electric motor within a motor housing includes seating a stator within a cavity of the motor housing collectively formed by sidewalls and an end for the motor housing, the stator having a stator core and windings on the stator core. The method also includes positioning a portion of the stator within a pilot bore recessed into a portion of the end of the motor housing, the pilot bore sized to receive the portion of the stator, where sidewall surfaces of the pilot bore contact peripheral surfaces of the stator core for a first distance along an axial direction of the stator. The method further includes constraining movement of the stator within the cavity by stator supports projecting from the sidewalls of the motor housing and contacting portions of the peripheral surfaces of the stator core, the portions of the peripheral surfaces of the stator core contacted by the stator supports being spaced apart in the axial direction from the portions of the peripheral surfaces of the stator core contacted by the sidewall surfaces of the pilot bore. The method additionally includes providing combined coolant and lubricant to flow through one or more channels each formed in the sidewalls of the motor housing between the pilot bore and the stator supports, the one or more channels each configured to leave a space between the sidewalls of the motor housing and the stator core to allow flow of the combined coolant and lubricant over the surfaces of the stator adjoining the channels.

In some embodiments, the portions of the peripheral surfaces of the stator core contacted by the sidewall surfaces of the pilot bore may be located at a first end of the stator core, and the portions of the peripheral surfaces of the stator core contacted by the stator supports may be located between a second end of the stator core and a midpoint of an axial length of the stator core.

In some embodiments, the channels may extend from the portions of the peripheral surfaces of the stator core contacted by the sidewall surfaces of the pilot bore to the portions of the peripheral surfaces of the stator core contacted by the stator supports.

In some embodiments, the channels may extend along the axial direction.

In some embodiments, the channels may be routed based on hotspots for the stator.

In some embodiments, the channels include reservoirs for accumulation of the combined coolant and lubricant at hotspots for the stator.

In some embodiments, when the stator is seated in the motor housing, ends of the windings may extend past the sidewall surfaces of the pilot bore contacted by the portions of the peripheral surfaces of the stator core.

In some embodiments, the stator supports may augment movement constraint provided by the pilot bore for the stator when the stator is seated in the motor housing.

In some embodiments, a motor including the motor housing may also include the stator seated within the motor housing, and a rotor rotatably mounted within the stator.

In some embodiments, an electric vehicle including the motor and motor housing may also include a cabin, where the motor is mounted inside a portion of the cabin, a drive system powered by the motor, and wheels mechanically coupled to the drive system.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 is a perspective view of a vehicle within which electric motor rotor/stator air gap control is implemented in accordance with embodiments of the present disclosure;

FIG. 2 diagrammatically depicts portions of an electric motor for use within an EV 100 with rotor/stator air gap control in accordance with embodiments of the present disclosure;

FIG. 3 illustrate a motor housing of the type diagrammatically depicted in FIG. 2;

FIGS. 4, 5, and 5A illustrate a motor housing of the type diagrammatically depicted in FIG. 2, for an electric motor with improved rotor/stator air gap control;

FIGS. 6 and 7 illustrate motor housings for an electric motor with rotor/stator air gap control in accordance with other embodiments of the present disclosure; and

FIG. 8 is a sectional view of a motor housing and stator for an electric motor with rotor/stator air gap control in accordance with embodiments of the present disclosure.

### DETAILED DESCRIPTION

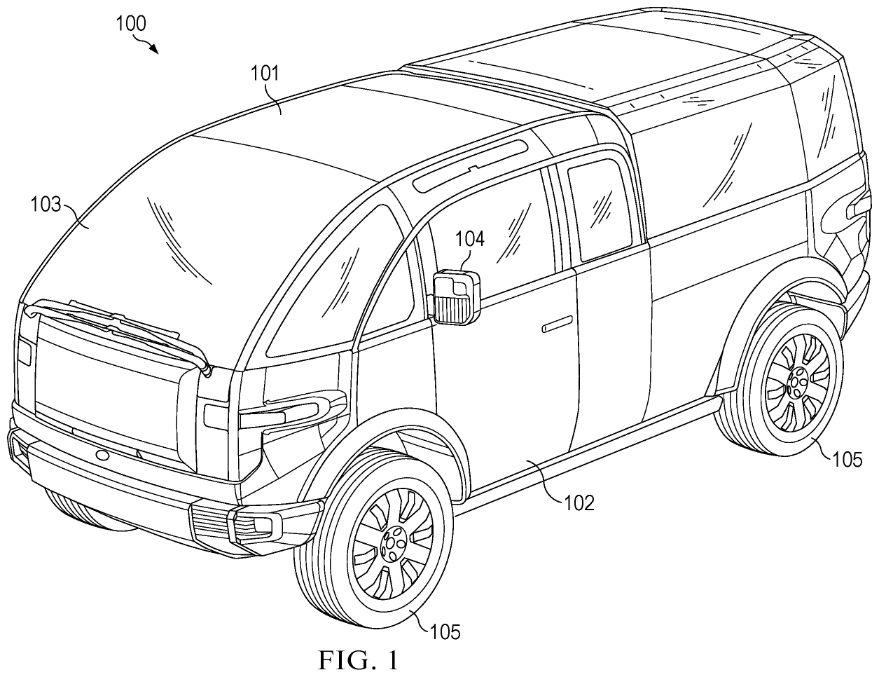

FIGS. 1 through 8, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

A consistent air gap (e.g., on the order of about 0.5 to 1.0 millimeters (mm)) between the stator and rotor is preferred. Changes in the air gap due to eccentricities in movement of the rotor or stator could damage the electric motor or reduce efficiency. Such eccentricities may result when a more powerful motor (e.g., 350 horsepower (hp) rather than 300 hp) causes deflection of the stator within the motor housing due to flexing of the housing as a result of the additional torque and/or use of a longer stator that is less fully constrained by a short pilot bore at one end thereof. In case of even minimal contact between the stator and rotor, damage to those components over time may degrade the useful life of the motor.

FIG. 1 is a perspective view of a vehicle 100 within which electric motor rotor/stator air gap control is implemented in accordance with embodiments of the present disclosure. The embodiment of the vehicle 100 illustrated in FIG. 1 is for illustration and explanation only. FIG. 1 does not limit the scope of this disclosure to any particular implementation.

The vehicle 100 of FIG. 1 includes a chassis (not visible in FIG. 1) supporting a cabin 101 for carrying at least one passenger (the operator) and optionally transporting cargo. The vehicle 100 is preferably an electric vehicle (EV) in which the chassis in some embodiments is in the form of a “skateboard” vehicle platform supporting one or more energy storage elements (e.g., batteries) that provide input electrical power used by various components of the EV, such as one or more electric motors of the vehicle 100 and a control system of the electric vehicle.

Passengers may enter and exit the cabin 101 through at least one door 102 forming part of the cabin 101. A transparent windshield 103 and other transparent panels mounted within and forming part of the cabin 101 allow at least one passenger (referred to as the “operator,” even when the vehicle 100 is operating in an autonomous driving mode) to see outside the cabin 101. Rear view mirrors 104 mounted to sides of the cabin 101 enable the operator to see objects to the sides and rear of the cabin 101 and may include warning indicators (e.g., selectively illuminated warning lights).

Wheels 105 mounted on axles that are supported by the chassis and driven by the motor(s) (all not visible in FIG. 1) allow the vehicle 100 to move smoothly. The wheels 105 are mounted on the axles in a manner permitting rotation relative to a longitudinal centerline of the vehicle 100 for steering and are also connected to steering controls (not visible). Conventional automobile features such as headlamps, taillights, turn signal indicators, windshield wipers, and bumpers are also depicted. The vehicle 100 may further include cargo storage within or connected to the cabin 101 and mounted on the chassis, with the cargo storage area(s) optionally partitioned by dividers from the passenger area(s) of the cabin 101.

In the present disclosure, the vehicle 100 includes an electric motor with shielding against shaft-induced common mode voltage.

Although FIG. 1 illustrates one example of a vehicle 100, those skilled in the art will recognize that the full structure and operation of a suitable vehicle are not depicted in the drawings or described here. Instead, for simplicity and clarity, only the structure and operation necessary for an understanding the present disclosure is depicted and described. Various changes may be made to the example of FIG. 1. In an exemplary embodiment, the electric motor described herein is a traction motor for the EV 100.

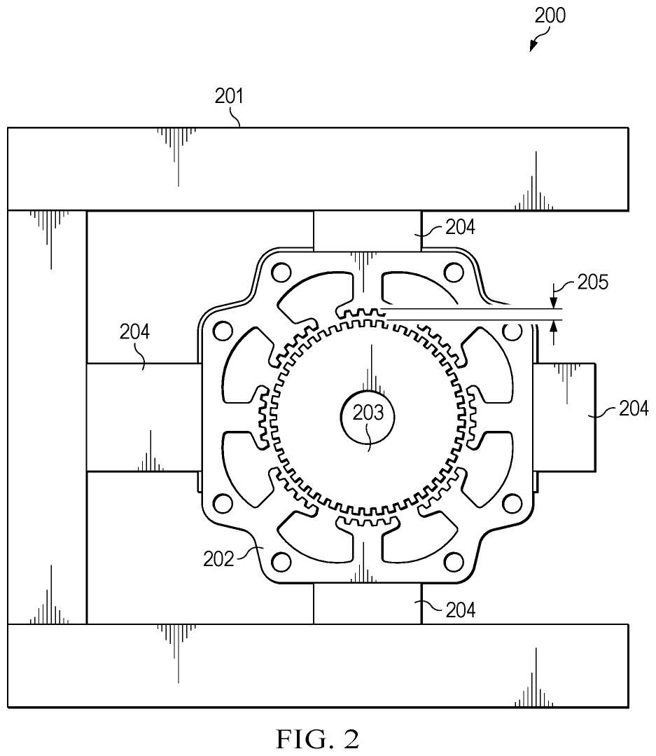

FIG. 2 diagrammatically depicts portions of an electric motor for use within an EV 100 with rotor/stator air gap control in accordance with embodiments of the present disclosure. The embodiment of the electric motor 200 and associated air gap illustrated in FIG. 2 are for illustration and explanation only. FIG. 2 does not limit the scope of this disclosure to any particular implementation of rotor/stator air gap control.

FIG. 2 depicts a motor housing 201 within which a stator 202 with a core and windings is disposed, and a rotor 203 mounted for rotation within the stator 202. The position of the rotor 203 within the stator 202 is constrained by bearing bores on each end of the rotor shaft, while the position of the stator within the motor housing 201 is constrained by machined surfaces 204 in the motor housing 201. An air gap 205 is left between the outermost portions of the rotor 203 and the innermost portions of the stator 202. In accordance with the known art, minimization of the air gap 205 improves motor efficiency, but the air gap 205 needs to be large enough to avoid contact by the rotor 203 with the stator 202 during rotation, taking into account various factors including (but not limited to) potential eccentricity in the rotor's rotation relative to the stator. Moreover, even without contact between the rotor 203 and the stator 202, for consistent performance and efficiency of the electric motor, the air gap 205 should not change during a cycle of rotation of the rotor 203 within the stator 202.

The stator 202 is best constrained when the stator 202 is held within the motor housing 201 by the machined surfaces 204 extending along a full length of the stator 202. However, the need for cooling channels between the stator 202 and the motor housing 201 may preclude such full length support. Such cooling channels are particularly needed with rainfall coolant circulation, to direct flow paths of the coolant during movement by gravity around and over surfaces of the stator.

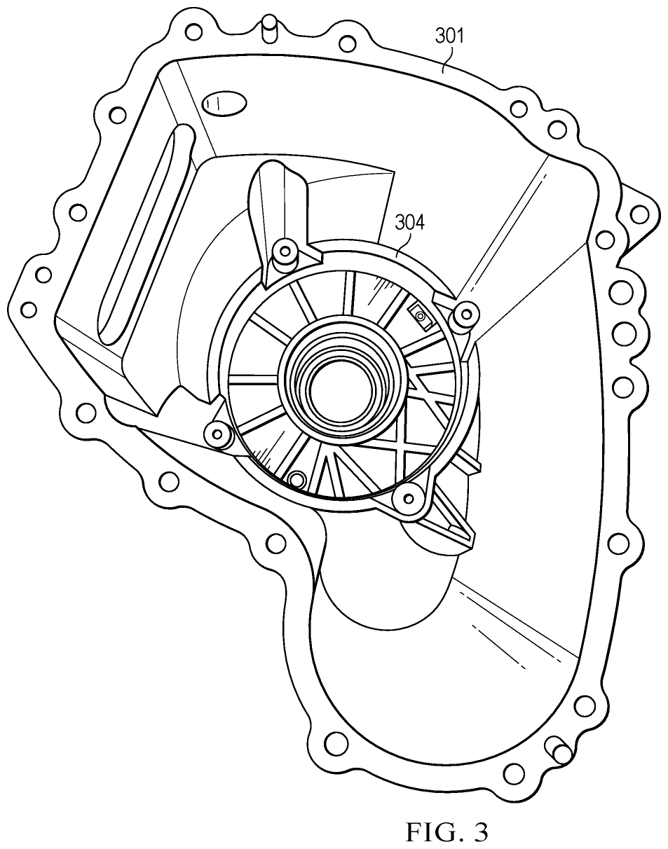

FIGS. 3, 4, 5, and 5A comparatively illustrate two different motor housings of the type diagrammatically depicted in FIG. 2, for an electric motor with rotor/stator air gap control. The embodiments of the motor housings 301, 401 illustrated in FIGS. 3, 4, 5, and 5A are for illustration and explanation only. FIGS. 3, 4, 5, and 5A do not limit the scope of this disclosure to any particular implementation of rotor/stator air gap control.

The motor housing 301 in FIG. 3 includes machined surfaces 304 in the shape of an annular recess or pilot bore, sized to receive one end of the stator (not shown). The annular pilot bore formed by machined surfaces 304 is relative short, compared to the length of the stator that is partially received by that bore (e.g., extending less than about 5-10 millimeters (mm) for a stator length of about 150 mm). The stator may be secured to the motor housing 301 by bolts within the holes visible in the illustration of FIG. 3, but the stator is still only held at one end, with the other end cantilevered.

Referring back to FIG. 2, if the machined surfaces 204 support the stator 202 only along a partial length thereof, the stator 202 is best constrained when the stator 202 is held at multiple spaced locations that are at or near both ends of the stator. However, tradeoffs may result in the machined surfaces 204 being positioned a distance along an axial length of the stator 202 from the ends.

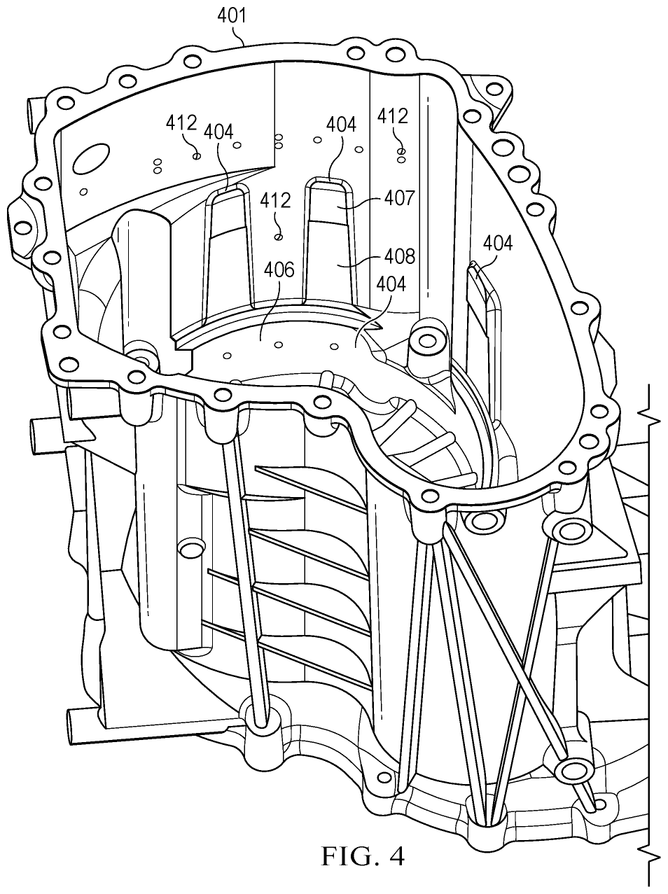

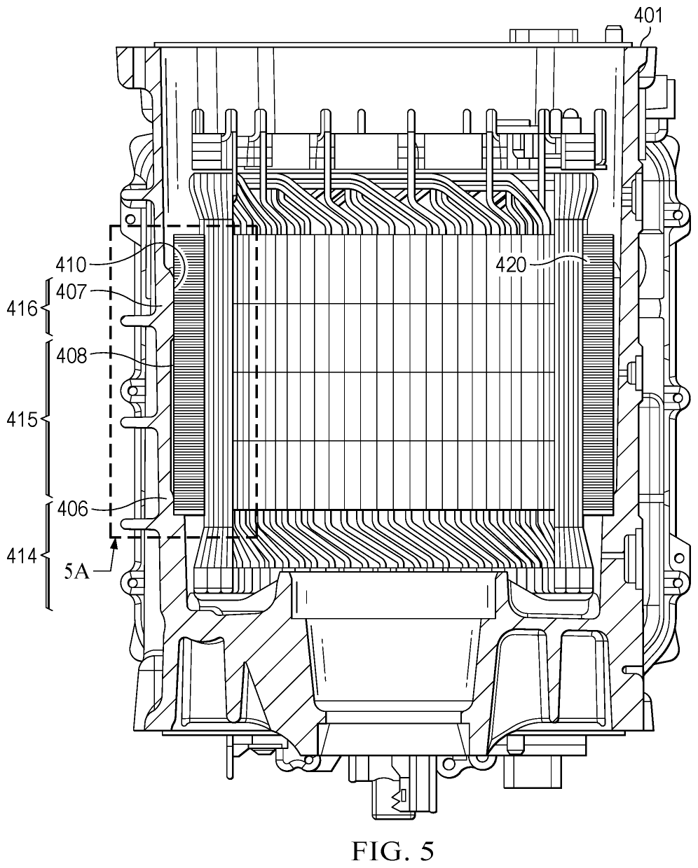

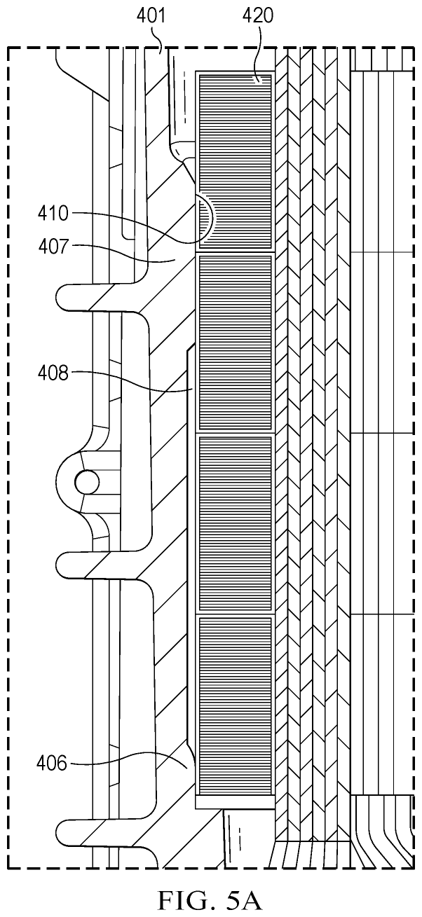

FIGS. 4 and 5-5A collectively illustrate portions of an electric motor with rotor/stator air gap control in accordance with embodiments of the present disclosure. FIG. 4 illustrates a motor housing alone, to show the interior thereof, while FIGS. 5 and 5A illustrate the motor housing with a stator mounted therein. FIG. 5A is an enlargement of the portion of FIG. 5 indicated by box A. The motor housing 401 includes sidewalls and an end forming a cavity for receiving the stator (and the rotor therein). The sidewalls of the cavity include machined surfaces 404 forming surface(s) of a pilot bore 414 and stator supports 407. The pilot bore 414 extends for a first axial length of the cavity internal to the motor housing 401. Selectively undercut regions 415 of the internal surface of the motor housing 401 form oil channels 408, and extend for a second axial length of the cavity internal to the motor housing 401, starting at an end of the pilot bore 414. Stator supports 407 in a region 416 that extends a third axial length along the cavity internal to the motor housing 401, starting at an end of the region 415 that includes the oil channels 408, each have a contact surface 410 forming a cross-sectional diameter approximately equal to the cross-sectional diameter of the contact surfaces 406 of the pilot bore 414. Accordingly, in the sectional the views of FIGS. 5 and 5A, the internal surface of motor housing 401 has contact surfaces 406 in the region of the pilot bore 414 and contact surfaces 410 in the region 416 of the stator supports 407, but has a larger internal cross-sectional diameter in the region 415 of the oil channels 408. As apparent from FIG. 4, however, the surfaces 406 forming the pilot bore 414 and the surfaces 410 forming the stator supports 407 are not continuous around an internal circumference of the motor housing 401, but instead may be spaced apart and separated by gaps around that internal circumference. The gaps, together with the oil channels 408, permit pumped or rainfall flow of a combined lubricant and coolant around and over surfaces of the stator.

The stator includes a stator core 420, within which are disposed windings. The stator core 420 (and windings therein) is received by the motor housing 401 and held therein. As shown in FIG. 5, the stator windings may project beyond an axial length of the stator core 420, projecting into the pilot bore 414 past the contact surfaces 406 of the pilot bore 414. Contact between internal contact surfaces 406, 410 of the motor housing 401 and external surfaces of the stator core 420 constrains stator movement during operation of the motor, for example due to rotation of the rotor within the stator. As shown in FIGS. 5 and 5A, the machined surfaces 404 forming contact surfaces 406 of the pilot bore 420 are positioned to contact a first end of the stator core 420. Contact surfaces 410 of the stator supports 407 are not positioned at the second, opposite end of the stator core 420, but are positioned beyond the midpoint of the axial length of the stator core 420 between the first and second ends thereof.

In the embodiment of FIGS. 4 and 5-5A, the motor housing 401 includes the machined surfaces 404 that include an annular pilot bore 414 similar to that of pilot bore 304, and undercut pads each including a stator support 407 and one or more oil channels 408. The contact surface(s) 406, 410 of the pilot bore 414 and the stator support 407 each contact an outer surface of the stator core 420 for the stator, while the surface of the oil channels 408 is spaced apart from the outer surface 410 of the stator, providing a flow path for coolant/lubricant around the outer surface of the stator. The stator supports 407 of the pad portions of the machined surfaces 404 are fully integrated features of the motor housing 401 (e.g., die cast aluminum) which encompasses the stator. The stator supports 407 may also act as heat sinks, conducting heat to coolant flowing in adjoining oil channels 408. The stator supports 407 may also act as heat sinks to conduct heat to the stator or to the housing. The stator supports 407 provide the necessary constraint against movement at or near the cantilevered end of the stator, thus allowing for tighter control over movement of stator—that is, the stator-to-rotor relative positioning—and therefore improved motor air gap control. The design illustrated allows for a better supported stator within the motor housing 401 while still allowing for a well-flowing rain manifold motor cooling system. The motor housing 401 in the example illustrated also includes oil jet ports 412 therein leading to conduits within the structure (sidewalls) of the motor housing 401. The conduits and oil jet ports 412 carry coolant/lubricant from a rain manifold above the stator to specific regions of the stator.

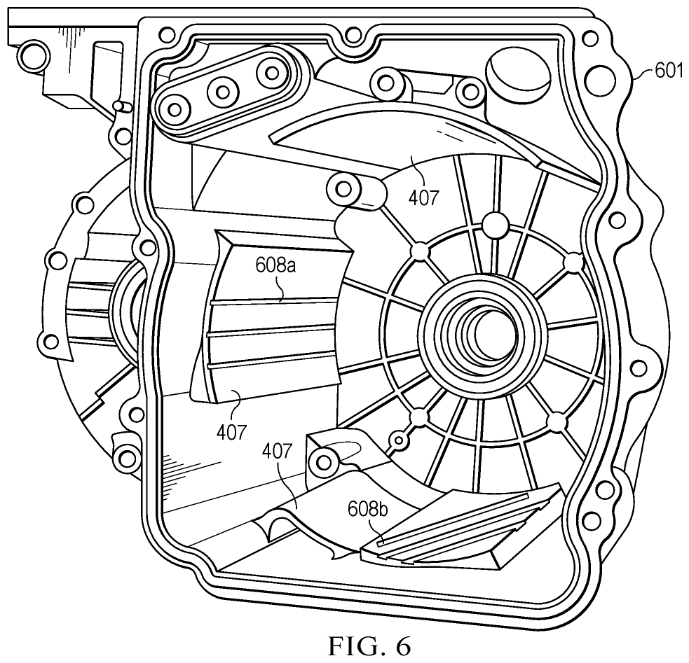

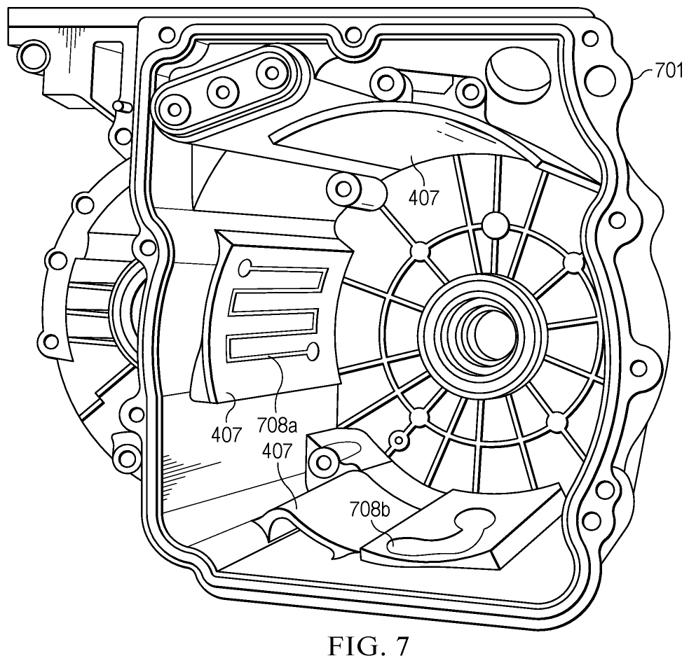

FIGS. 6 and 7 illustrate motor housings for an electric motor with rotor/stator air gap control in accordance with other embodiments of the present disclosure. The embodiments of the motor housings 601, 701 illustrated in FIGS. 6 and 7 are for illustration and explanation only. FIGS. 6 and 7 do not limit the scope of this disclosure to any particular implementation of rotor/stator air gap control.

The oil channels within the machined, internal surfaces of the motor housing may be straight horizontal, vertical, or slanted channels 608a or 608b, routed based on hotspots for the motor. Alternatively, the oil channels may zig-zag channels 708a for pressurized (e.g., pumped) oil, or may be shaped to include reservoir areas 708b targeting known hot spots on the stator, for accumulation of the coolant/lubricant in the area(s) of such hotspots. The reservoirs may be connected to oil jet ports (for example, oil jet ports 412) such that coolant/lubricant flows inside portions of the structure of the motor housing but flows to the internal surface of the motor housing and along the stator in the regions of hotspots for the stator.

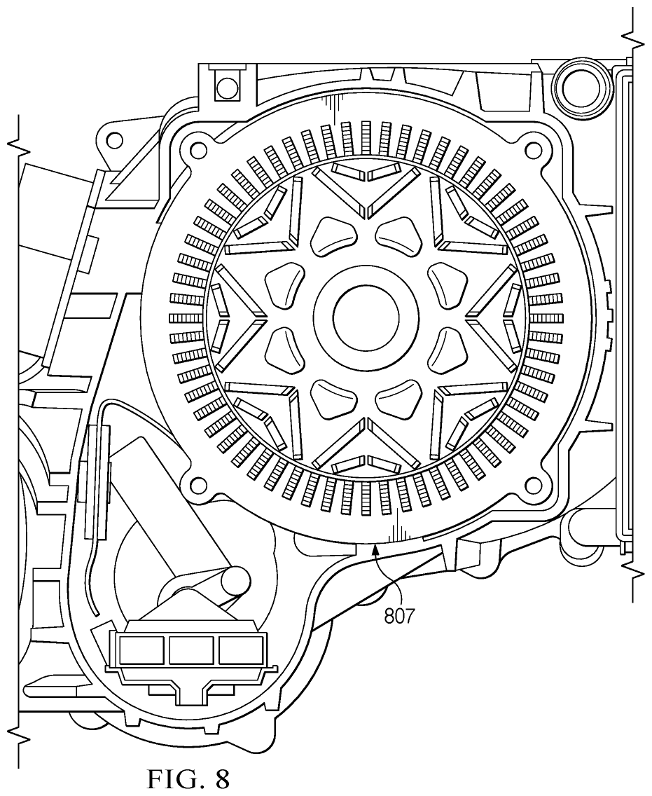

FIG. 8 is a sectional view of a motor housing and stator for an electric motor with rotor/stator air gap control in accordance with embodiments of the present disclosure. The embodiment of the motor housing 801 illustrated in FIG. 8 is for illustration and explanation only. FIG. 8 does not limit the scope of this disclosure to any particular implementation of rotor/stator air gap control.

As shown in FIG. 8, one of the stator supports 807 that contact an external surface of the stator may be positioned to act as a “dam” facilitating accumulation of coolant/lubricant at a hot spot located at the bottom of the stator.

While described as suitable for rainfall cooling/lubrication, the present disclosure may also be used with pumped (mechanically pressurized) oil flows.

Electric motors that incorporate a rain manifold cooling system need well-flowing coolant liquid around motor stator end windings and core. For that reason, full support of the motor stator is difficult, as any fully supporting structure implemented will impact on the liquid flow path and therefor impact overall motor cooling. The designs disclosed herein are a fully integrated solution with no additional parts added, simply utilizing an already existing part (motor housing) modified to incorporate strategically placed supporting pad features to control stator relative positioning to the motor rotor. The stator supporting pads are cast features of the motor housing that undergoes machining operations for required surface finishes and tolerancing. This solution achieves a minimal increase to motor housing production cycle time. The solution achieved will successfully control the motor stator relative positioning to motor rotor by mechanically providing physical positioning limits to the stator itself, without impacting the stator to motor housing assembly as the applied supporting pads are strategically placed to prevent stator binding in motor housing during assembly.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A motor housing, comprising:
sidewalls and an end collectively forming a cavity configured to receive a stator having a stator core and windings on the stator core;
a pilot bore recessed into a portion of the end of the motor housing, the pilot bore sized to receive a portion of the stator, wherein sidewall surfaces of the pilot bore contact peripheral surfaces of the stator core for a first distance along an axial direction of the stator;
stator supports projecting from the sidewalls of the motor housing and contacting portions of the peripheral surfaces of the stator core, the portions of the peripheral surfaces of the stator core contacted by the stator supports spaced apart in the axial direction from the portions of the peripheral surfaces of the stator core contacted by the sidewall surfaces of the pilot bore; and
one or more channels each formed in the sidewalls of the motor housing between the pilot bore and the stator supports, the one or more channels each configured to leave a space between the sidewalls of the motor housing and the stator core to allow flow of combined coolant and lubricant over the surfaces of the stator adjoining the channels.

2. The motor housing according to claim 1, wherein the portions of the peripheral surfaces of the stator core contacted by the sidewall surfaces of the pilot bore are located at a first end of the stator core, and the portions of the peripheral surfaces of the stator core contacted by the stator supports are located between a second end of the stator core and a midpoint of an axial length of the stator core.

3. The motor housing according to claim 1, wherein the channels extend from the portions of the peripheral surfaces of the stator core contacted by the sidewall surfaces of the pilot bore to the portions of the peripheral surfaces of the stator core contacted by the stator supports.

4. The motor housing according to claim 1, wherein the channels extend along the axial direction.

5. The motor housing according to claim 1, wherein the channels are routed based on hotspots for the stator.

6. The motor housing according to claim 1, wherein the channels include reservoirs for accumulation of the combined coolant and lubricant at hotspots for the stator.

7. The motor housing according to claim 1, wherein, when the stator is seated in the motor housing, ends of the windings extend past the sidewall surfaces of the pilot bore contacted by the portions of the peripheral surfaces of the stator core.

8. The motor housing according to claim 1, wherein the stator supports augment movement constraint provided by the pilot bore for the stator when the stator is seated in the motor housing.

9. A motor comprising the motor housing according to claim 1, the motor further comprising:
the stator seated within the motor housing; and
a rotor rotatably mounted within the stator.

10. An electric vehicle (EV) comprising the motor according to claim 9, the EV further comprising:
a cabin, wherein the motor is mounted inside a portion of the cabin;
a drive system powered by the motor; and
wheels mechanically coupled to the drive system.

11. A method of cooling an electric motor within a motor housing, the method comprising:
seating a stator within a cavity of the motor housing collectively formed by sidewalls and an end for the motor housing, the stator having a stator core and windings on the stator core;
positioning a portion of the stator core within a pilot bore recessed into a portion of the end of the motor housing, the pilot bore sized to receive the portion of the stator, wherein sidewall surfaces of the pilot bore contact peripheral surfaces of the stator core for a first distance along an axial direction of the stator;
constraining movement of the stator within the cavity by stator supports projecting from the sidewalls of the motor housing and contacting portions of the peripheral surfaces of the stator core, the portions of the peripheral surfaces of the stator core contacted by the stator supports spaced apart in the axial direction from the portions of the peripheral surfaces of the stator core contacted by the sidewall surfaces of the pilot bore; and
providing combined coolant and lubricant to flow through one or more channels each formed in the sidewalls of the motor housing between the pilot bore and the stator supports, the one or more channels each configured to leave a space between the sidewalls of the motor housing and the stator core to allow flow of the combined coolant and lubricant over the surfaces of the stator adjoining the channels.

12. The method according to claim 11, wherein the portions of the peripheral surfaces of the stator core contacted by the sidewall surfaces of the pilot bore are located at a first end of the stator core, and the portions of the peripheral surfaces of the stator core contacted by the stator supports are located between a second end of the stator core and a midpoint of an axial length of the stator core.

13. The method according to claim 11, wherein the channels extend from the portions of the peripheral surfaces of the stator core contacted by the sidewall surfaces of the pilot bore to the portions of the peripheral surfaces of the stator core contacted by the stator supports.

14. The method according to claim 11, wherein the channels extend along the axial direction.

15. The method according to claim 11, wherein the channels are routed based on hotspots for the stator.

16. The method according to claim 11, wherein the channels include reservoirs for accumulation of the combined coolant and lubricant at hotspots for the stator.

17. The method according to claim 11, wherein ends of the windings extend past the sidewall surfaces of the pilot bore contacted by the portions of the peripheral surfaces of the stator core.

18. The method according to claim 11, wherein the stator supports augment movement constraint provided by the pilot bore for the stator.

19. The method according to claim 11, further comprising:
rotatably mounting a rotor within the stator.

20. The method according to claim 19, wherein the electric motor is mounted inside a portion of a cabin for an electric vehicle (EV), the method further comprising:
powering a drive system by the motor; and
driving wheels mechanically coupled to the drive system.
